(19) United States
(12) Patent Application Publication
(10) Pub. No.: US 2011/0096697 A1
(43) Pub. Date: Apr. 28, 2011

(54) Automatic Selection of Geographic Area Specific Behavior

(75) Inventors: Karthik Anantharaman, San Diego, CA (US); Parag M. Kanade, San Diego, CA (US)

(73) Assignee: QUALCOMM Incorporated, San Diego, CA (US)

(21) Appl. No.: 12/607,743

(22) Filed: Oct. 28, 2009

(51) Int. Cl. H04L 12/28

(52) U.S. Cl. 370/254

(57) ABSTRACT

A wireless communication device configured for automatic selection of geographic specific behavior is described. The circuitry is configured to receive a message with system information from the network that is mandatorily sent from a base station. The circuitry is also configured to determine the geographic area from the system information using a lookup table.

### TECHNICAL FIELD

The present disclosure relates generally to wireless communications. More specifically, the present disclosure relates to automatic selection of country specific behavior in wireless communications.

### BACKGROUND

Wireless communication devices have become smaller and more powerful in order to meet consumer needs and to improve portability and convenience. Consumers have become dependent upon wireless communication devices such as cellular telephones, personal digital assistants (PDAs), laptop computers, and the like. Consumers have come to expect reliable service, expanded areas of coverage, and increased functionality. A wireless communication device may be referred to as a mobile station, a subscriber station, an access terminal, a remote station, a user terminal, a terminal, a subscriber unit, user equipment (UE), etc. For clarity and ease of explanation, the term “UE” is used hereinbelow.

UEs have become increasingly mobile. The global nature of a UE may make operation possible in multiple geographic areas and/or multiple countries. A UE may use different operating procedures for each geographic area/country. When traveling between geographic areas/countries, it may be beneficial for the UE to determine the current country or geographic area in order to apply the operating procedures specific to that geographic area/country.

### BRIEF DESCRIPTION OF THE DRAWINGS

FIG. 1 illustrates a wireless communication system including a base station in wireless electronic communication with a UE;

FIG. 2 is a flow diagram illustrating a method for automatic selection of geographic area specific behavior by a UE;

FIG. 3 is a block diagram illustrating various components of one configuration of a UE for use in the present systems and methods;

FIG. 4 is a flow diagram illustrating a method for automatic selection of geographic area specific behavior by a UE;

FIG. 5 is a flow diagram illustrating a method for automatic selection of country specific behavior by a UE;

FIG. 6 is a sequence diagram illustrating data flows between a base station and a UE;

FIG. 7 illustrates a base station sending a sync channel message to a UE in a wireless communication system;

FIG. 8 illustrates one configuration of a lookup table for use in the present systems and methods; and

FIG. 9 shows part of a hardware implementation of an apparatus that is configured for automatic selection of geographic area specific behavior.

### DETAILED DESCRIPTION

A wireless communication device such as a user equipment (UE) may be used in multiple countries and/or multiple geographic areas. For example, the wireless communication device may be used for international travel. Depending on the location of the wireless communication device, certain features may be available that were not previously available. For instance, the wireless communication device may have certain features available in London that are not available or appropriate in New York City.

The wireless communication device may be unable to determine the country/geographic area location. Without the country knowledge, the wireless communication device may be unable to have country specific behavior. Code division multiple access (CDMA) standards have the provision for sending a Mobile Country Code (MCC) and Mobile Network Code (MNC) over the air from a base station. The MCC can uniquely identify the country where the wireless communication device has acquired service. However, most CDMA operators do not transmit valid MCC values, so the wireless communication device may be unable to use the MCC values to determine the current country/location.

The wireless communication device may use other methods to determine the country/location where the wireless communication device has acquired service. The wireless communication device may receive parameters such as the sector identification (SID), network identification (NID), local time offset (LTM) and day light savings (DAYLT) from the CDMA network which the wireless communication device has acquired service with. The wireless communication device may then use the parameters to determine the current country/location. For example, the wireless communication device may compare the parameters with a look up table to determine the current country/location. The wireless communication device may then apply country specific applications and algorithms for the current country/location.

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA), and other systems. The terms “system” and “network” are used interchangeably herein. A CDMA system can implement a radio technology such as Universal Terrestrial Radio Access (UTRA), CDMA2000, etc. UTRA includes Wideband-CDMA (W-CDMA) and other variants of CDMA. CDMA2000 covers the IS-2000, IS-95, and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink.

A wireless communication device may be referred to as a mobile station, a subscriber station, an access terminal, a remote station, a user terminal, a terminal, a subscriber unit, user equipment (UE), etc. For clarity and ease of explanation, the term “UE” is used hereinbelow.

A wireless communication system may provide communication for a number of cells, each of which may be serviced by a base station. A base station may be a fixed station that communicates with UEs. A base station may alternatively be referred to as an access point or some other terminology.

A UE may communicate with one or more base stations via transmissions on the uplink and the downlink. The uplink (or reverse link) refers to the communication link from the UE to the base station, and the downlink (or forward link) refers to the communication link from the base station to the UE. A wireless communication system may simultaneously support communication for multiple UEs.

Wireless communication systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, orthogonal frequency division multiple access (OFDMA) systems, and spatial division multiple access (SDMA).

CDMA standards allow base stations to transmit Mobile Country Codes (MCCs) and Mobile Network Codes (MNCs) to help identify the country where a mobile UE has acquired service. However, most CDMA operators do not transmit valid MCC parameters, so that in most cases, the mobile UE cannot obtain the MCC information directly from base station transmissions. In some CDMA systems, for example, “wildcard” values are transmitted in place of actual MCC and MNC values. To compensate for not having the MCC information, some operators employ specific solutions, such as feature notification, to provide a text message with the name of the current serving country. However, including feature notification is not universally employed. Hence, in some mobile phone scenarios, the serving country is not known.

Typical CDMA networks transmit certain parameters which may be used to automatically identify the current serving country. For example, the System Identification (SID) specifies the set of all base stations within a service area. In one example, the SID is specified with 15 bits. In another example, the Network Identification (NID) specifies a subset of base stations within a service area, for example, a group of base stations controlled by a single base station controller. In one example, the NID is specified with 16 bits. Both the SID and NID are broadcast by base stations so that mobile UEs may determine the system and network. In addition, base stations also broadcast a local time offset (LTM_OFF), which is a 6 bit correction value to system time and the DAYLT flag, which is a 1 bit indicator which specifies if daylight savings is in effect or not. These parameters may be used to help identify the current serving country.

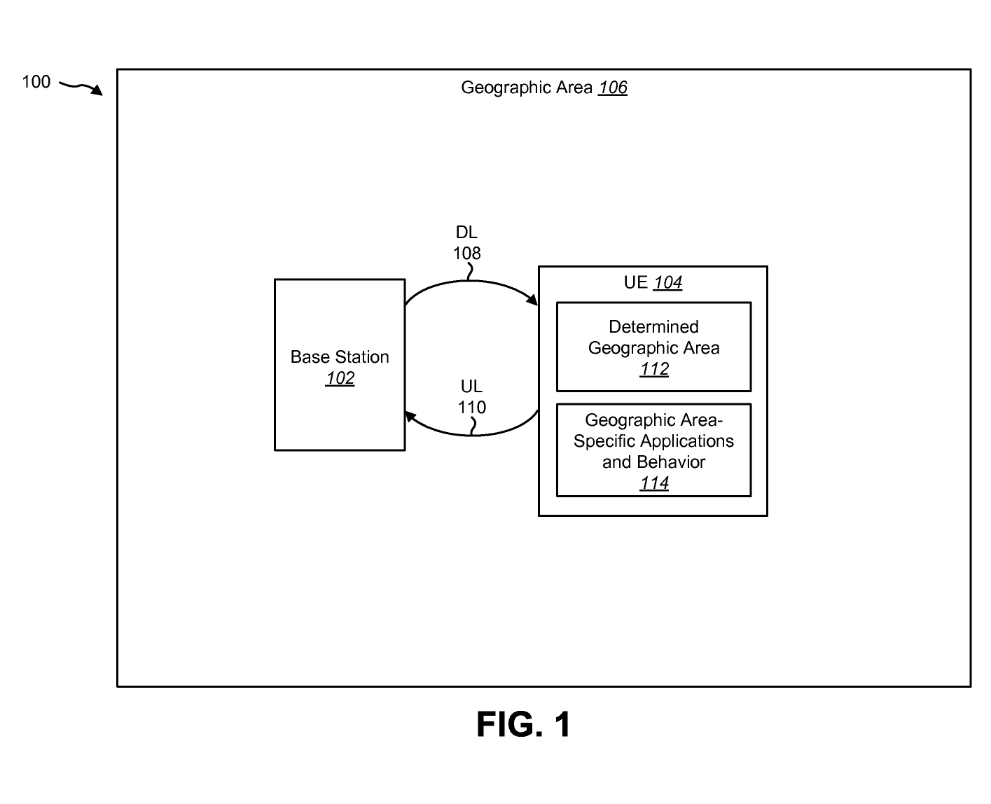

FIG. 1 illustrates a wireless communication system 100 including a base station 102 in wireless electronic communication with a UE 104. The UE 104 may be a mobile station such as a mobile phone or a wireless networking card. The base station 102 may be capable of communicating with multiple UEs 104 at the same time. For example, although only a single UE 104 is shown in wireless electronic communication with the base station 102 in FIG. 1, multiple UEs 104 may also simultaneously communicate with the base station 102.

The base station 102 may communicate electronically with the UE 104. For example, the base station 102 may send electronic communications to the UE 104 over a downlink transmission 108. Similarly, the UE 104 may send electronic communications to the base station 102 over an uplink transmission 110.

The base station 102 and the UE 104 may be located within a geographic area 106. For example, the geographic area 106 may be a country. As another example, the geographic area 106 may be a specific location within a country, such as a state, a principality, an island, etc. The geographic area 106 of the base station 102 and UE 104 may be known to the base station 102. However, the geographic area 106 of the base station 102 and UE 104 may be unknown to the UE 104.

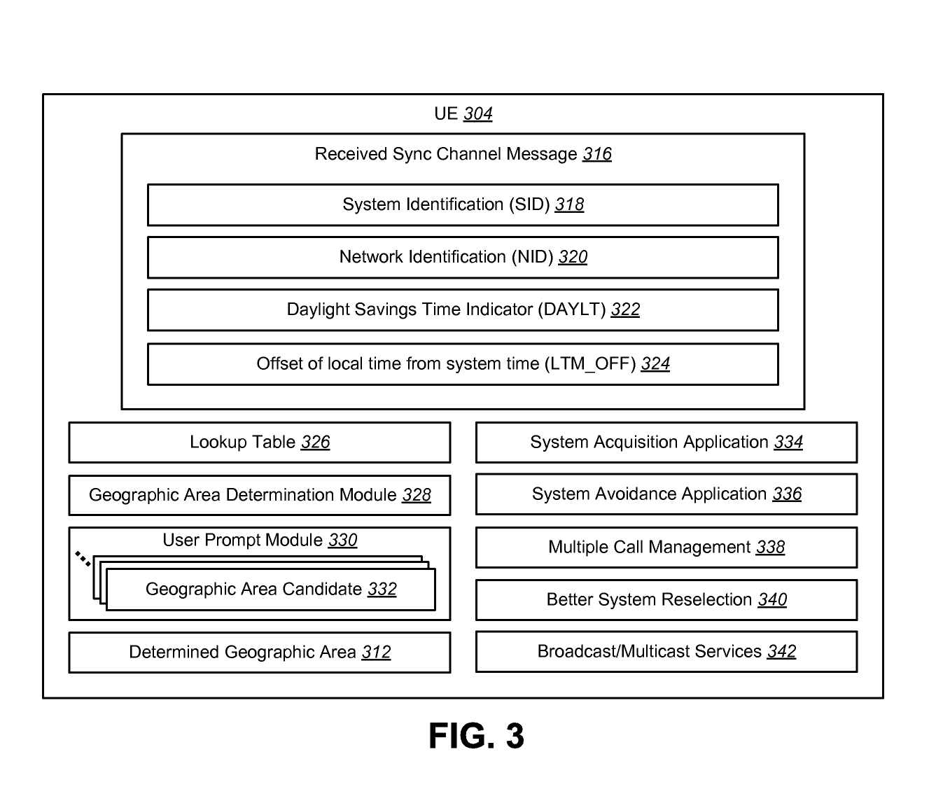

The UE 104 may include a determined geographic area 112. The determined geographic area 112 may be the current geographic area 106 of the UE 104. For example, the UE 104 may determine the current geographic area 106 and store this value as the determined geographic area 112. The UE 104 may also include geographic area specific applications and behavior 114. The applications and behavior 114 that are specific to the geographic area 112 are discussed in further detail below in relation to FIG. 3.

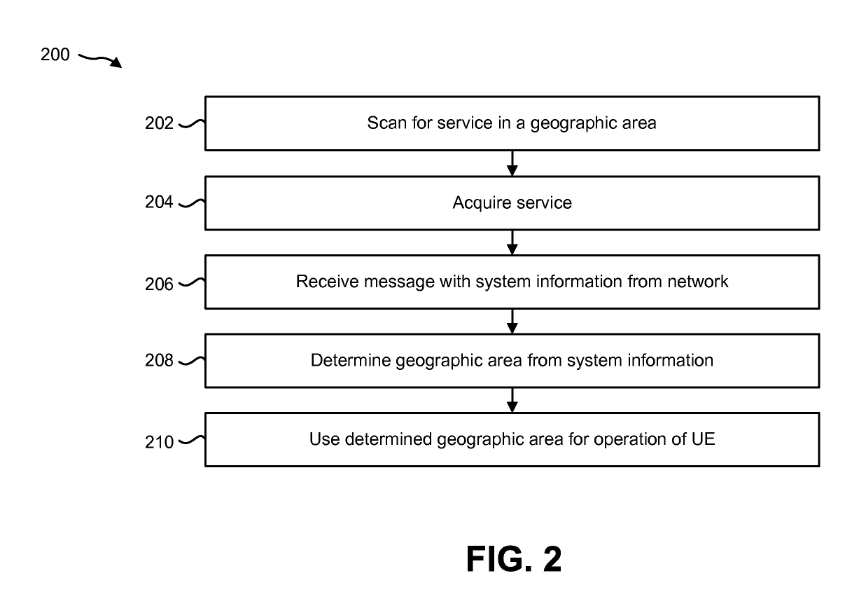

FIG. 2 is a flow diagram illustrating a method 200 for automatic selection of geographic area specific behavior by a UE 104. The UE 104 may scan 202 for service in a current geographic area 106. In one configuration, the UE 104 may have moved from a first geographic area 106 to a second geographic area 106 prior to scanning for service in the second/current geographic area 106. Alternatively, the UE 104 may have been powered off prior to transferring from the first geographic area 106 to the second/current geographic area 106. Thus, the UE 104 may have been powered on in the second/current geographic area 106.

The UE 104 may acquire 204 service. The service may be from a base station 102 located within the current geographic area 106. For example, the service may be from a base station 102 located within the current country of the UE 104. The UE 104 may then receive 206 a message with system information from a network. The network may be associated with the base station 102. For example, the base station 102 may provide access between the UE 104 and the network. The system information may include information specific to the network and/or the base station 102. For example, the system information may include identification of the network, identification of the service provider associated with the network and identification of the base station 102.

The UE 104 may determine 208 the geographic area 106 from the system information. The UE 104 may then use 210 the determined geographic area 112 for operation of the UE 104. Operating parameters of the UE 104 may depend on the determined geographic area 112. For example, the calling behavior of the UE 104 may depend on the determined geographic area 112. Applications and behavior 114 of the UE 104 specific to the geographic area 106 are discussed in further detail below in relation to FIG. 3.

FIG. 3 is a block diagram illustrating various components of one configuration of a UE 304 for use in the present systems and methods. The UE 304 of FIG. 3 may be one configuration of the UE 104 of FIG. 1. The UE 304 may include a received sync channel message 316. The received sync channel message 316 may be received from a base station 102. The received sync channel message 316 may be received via the data channel. It may be mandatory for a base station 102 to send the sync channel message 316 to each UE 304 at registration. It may also be mandatory that the sync channel message 316 includes correct values. For example, the base station 102 and the UE 304 may be configured to operate in accordance with a particular wireless communication standard (e.g., a CDMA standard), and the standard may specify that the base station 102 is required to send the sync channel message 316 to each UE 304 at registration, and that the sync channel message 316 is required to include correct values.

The received sync channel message 316 may include network information. The network information may assist the UE 304 in identifying the network and equipment associated with the network. The received sync channel message 316 may include a system identification (SID) 318. The SID 318 may be set to the system identification number for the system by the base station 102. The received sync channel message 316 may also include a network identification (NID) 320. The NID 320 may serve as a sub-identifier of a system as defined by the owner of the SID 318. The NID 320 may be set to the network identification number for the network.

The received sync channel message 316 may also include a daylight savings time indicator (DAYLT) 322. The daylight savings time indicator 322 may indicate whether daylight savings time is in effect for the geographic area 106 of the network. If daylight savings time is in effect, the base station 102 may set the DAYLT 322 field to 1; otherwise, the base station 102 may set the DAYLT 322 field to 0. The received sync channel message 316 may also include an offset of local time from system time (LTM_OFF) 324. The LTM_OFF 324 may be set by the base station 102 to the two's complement offset of local time from System Time, in units of 30 minutes. The local time of day, in units of 80 milliseconds (ms), as of four Sync Channel superframes (320 ms) after the end of the last superframe containing any part of the Sync Channel Message minus the pilot PN sequence offset, may be equal to SYS_TIME−(LP_SEC×12.5)+(LTM_OFF×22500).

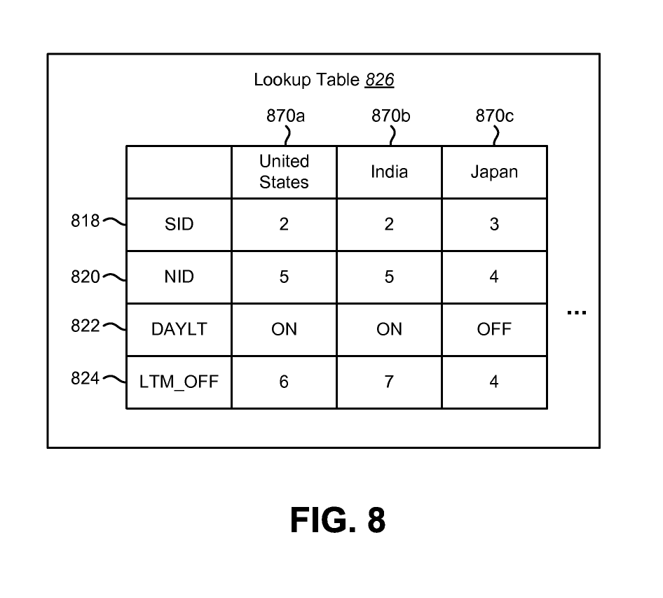

The UE 304 may also include a lookup table 326. Lookup tables 326 are discussed in further detail below in relation to FIG. 8. The lookup table 326 may include entries for geographic areas 106 where the UE 304 may operate. For example, the lookup table 326 may include an entry for each country providing cellular service to the UE 304. The lookup table 326 may include identification information for the geographic areas 106. For example, the lookup table 326 may include the SID 318, NID 320, DAYLT 322, and LTM_OFF 324 values for each geographic area 106. The UE 304 may use the lookup table 326 to identify the current geographic area 106 of the UE 304.

The UE 304 may also include a geographic area determination module 328. The geographic area determination module 328 may use the information within the received sync channel message 316 along with the lookup table 326 to determine the current geographic area 106 of the UE 304. The geographic area determination module 328 may thus use the information within the received sync channel message 316 to determine a determined geographic area 312. In one configuration, the geographic area determination module 328 may be unable to determine the current geographic area 106 with certainty. For example, multiple geographic areas 106 may use the same SID 318 within the same timezone. The geographic area determination module 328 may then determine two or more geographic area candidates 332. The geographic area candidates 332 may be the most likely candidates for the current geographic area 106.

The UE 304 may include a user prompt module 330. The user prompt module 330 may include the two or more geographic area candidates 332. The user prompt module 330 may present the geographic area candidates 332 to a user of the UE 304. A user of the UE 304 may then select the determined geographic area 312 from the geographic area candidates 332.

The UE 304 may include behavior and applications that are specific to a geographic area 106. For example, certain applications and behavior may only be appropriate for certain geographic areas 106. As another example, certain applications may use different operations specific to the current geographic area 106. Furthermore, the UE 304 behavior may be specific to the current geographic area 106.

The UE 304 may include geographic area specific system acquisition applications 334. Each geographic area 106 may include unique system acquisition algorithms. Examples of geographic area specific system acquisition applications 334 include the frequencies scanned when searching for a network, the amount of time spent searching for a pilot signal before entering a sleep mode, the amount of time spent in sleep mode, and the PN codes used.

The UE 304 may also include geographic area specific system avoidance applications 336. Each geographic area 106 may include unique system avoidance algorithms. System avoidance applications and algorithms may prevent a UE 304 from selecting improper parameters and/or choosing parameters causing sub-optimal behavior. For example, if an SID of 1000 is present in both the USA and Japan, and a carrier in Japan has an SID of 1000, country based logic may ensure that a UE 304 does not select any SID other than 1000 while in Japan. In contrast, the UE 304 may select SIDs other than 1000 while in the USA.

The UE 304 may include geographic area specific multiple call management algorithms 338. For example, each geographic area 106 may have specific protocols for handling multiple calls. Depending on the determined geographic area 312, the UE 304 may use the protocols for handling multiple calls specific to the determined geographic area 312. The UE 304 may also include geographic area specific better system reselection algorithms 340. Examples of geographic area specific better system reselection algorithms 340 may include the frequency of searching for a home provider, the use of different base station searching algorithms, out of service scanning, and fading algorithms. The UE 304 may further include broadcast/multicast services 342. Broadcast/multicast services 342 may be available in certain countries and not available in other countries. The UE 304 may scan channels for broadcast/multicast services 342 in one country more aggressively than in another. For example, searching for broadcast/multicast services 342 in countries where broadcast/multicast services 342 are not available may waste the battery of the UE 304.

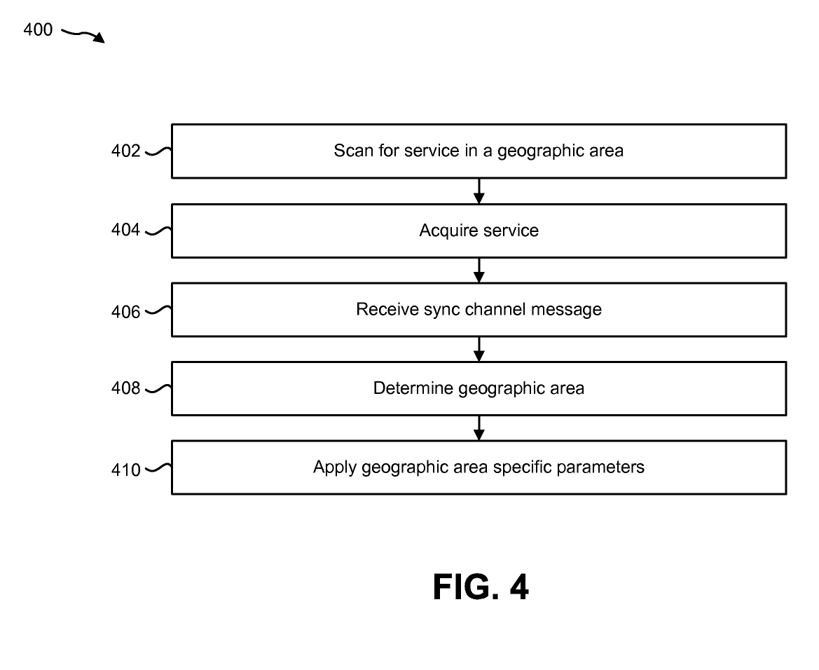

FIG. 4 is a flow diagram illustrating a method 400 for automatic selection of geographic area specific behavior by a UE 104. The UE 104 may scan 402 for service in a geographic area 106. In one configuration, the geographic area 106 may be a country. The UE 104 may then acquire 404 service in the geographic area 106. The UE 104 may receive 406 a sync channel message 316. The sync channel message 316 may be received from a base station 102 in the geographic area 106. Based on the sync channel message 316, the UE 104 may determine 408 the geographic area 106. For example, if the geographic area 106 is a country, the UE 104 may use the sync channel message 316 to determine which country the geographic area 106 is. The UE 104 may then apply 410 geographic area specific parameters to the operation of the UE 104.

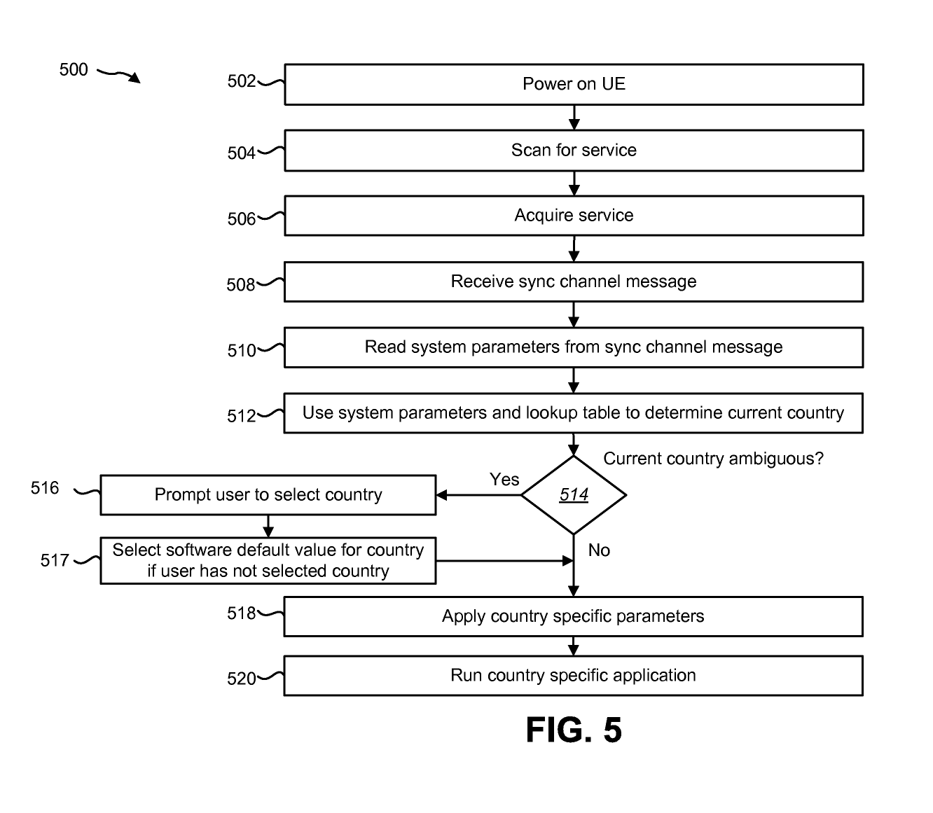

FIG. 5 is a flow diagram illustrating a method 500 for automatic selection of country specific behavior by a UE 104. A user of the UE 104 may power on 502 the UE 104. The UE 104 may then scan 504 for service. The UE 104 may acquire 506 service. The UE 104 may then receive 508 a sync channel message 316. The UE 104 may receive 508 the sync channel message 316 from the network that the UE 104 has acquired service with. The sync channel message 316 may include system parameters. Sync channel messages 316 were discussed above in relation to FIG. 3. The UE 104 may read 510 the system parameters from the sync channel message 316. The UE 104 may then use 512 the system parameters and a lookup table 326 to determine the current country.

The UE 104 may next determine 514 if the current country is ambiguous. For example, the UE 104 may determine whether the system parameters received in the sync channel message 316 indicate only one possible current country candidate or multiple potential current country candidates. If the current country is ambiguous, the UE 104 may prompt 516 the user of the UE 104 to select the current country. In one configuration, the UE 104 may prompt 516 the user of the UE 104 to select the current country from a list of potential country candidates. Alternatively, the UE 104 may prompt 516 the user to select whether a specific country is the current country. If the UE 104 has determined that the current country is not ambiguous or the user has selected a country, the UE 104 may then apply 518 country specific parameters corresponding to the current country. If the user has not selected a country, the UE may select 517 a software default value for the country. The UE 104 may then run 520 country specific applications. Country specific applications were discussed above in relation to FIG. 3.

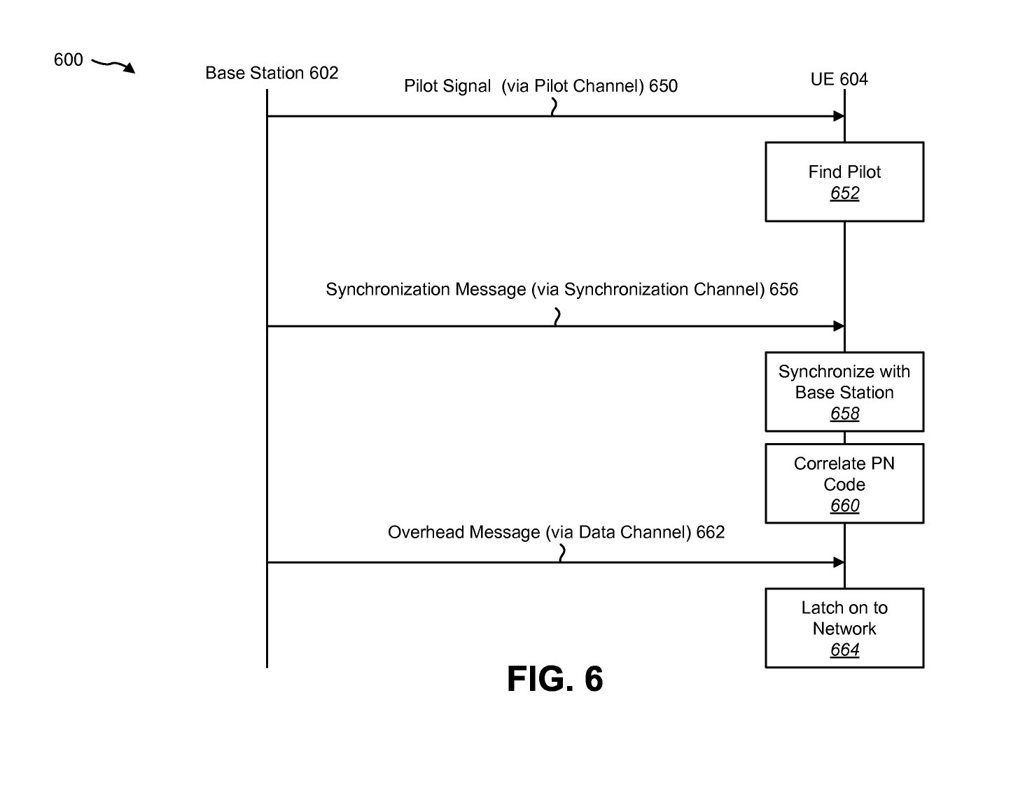

FIG. 6 is a sequence diagram illustrating data flows 600 between a base station 602 and a UE 604. The base station 602 may send 650 a pilot signal to the UE 604. The base station 602 may send 650 the pilot signal to the UE 604 via a pilot channel. The UE 604 may find 652 the pilot signal. The base station 602 may then send 656 a synchronization message 316 to the UE 604 via the synchronization channel. Upon receiving the synchronization message 316, the UE 604 may synchronize 658 with the base station 602. The UE 604 may then correlate 660 the pseudo-noise (PN) codes with the base station 602. The base station 602 may next send 662 an overhead message to the UE 604. The base station 602 may send 662 the overhead message to the UE 604 via the data channel. Upon receiving the overhead message, the UE 604 may latch 664 on to the network of the base station 602.

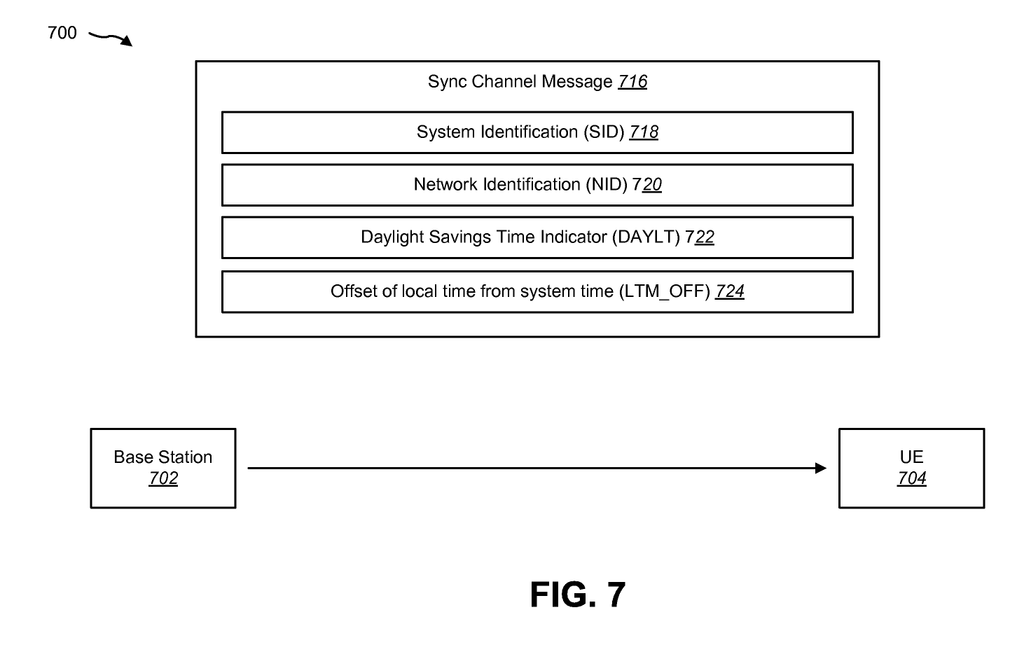

FIG. 7 illustrates a base station 702 sending a sync channel message 716 to a UE 704 in a wireless communication system 700. The sync channel message 716 may be sent on the synchronization channel. The sync channel message 716 may include network information for the base station 702. A sync channel message 716 may include a system identification (SID) 718, a network identification (NID) 720, a daylight savings time indicator (DAYLT) 722, and an offset of local time from System Time (LTM_OFF) 724.

FIG. 8 illustrates one configuration of a lookup table 826 for use in the present systems and methods. The lookup table 826 of FIG. 8 may be one configuration of the lookup table 326 of FIG. 3. The lookup table 826 may be preprogrammed for each UE 104. For example, a UE 104 may not update entries within the lookup table 826. Alternatively, a UE 104 may update entries in the lookup table 826 as new information is passed from a network to the UE 104.

The lookup table 826 may include network information pertaining to multiple geographic areas 106. For example, the lookup table 826 may include network information pertaining to multiple countries such as the United States 870a, India 870b, and Japan 870c. The network information may include an SID 818, an NID 820, a value for DAYLT 822, and a value for L™ OFF 824. These values may assist the UE 104 in determining the current country. The network information for different countries may be ambiguous. For example, the SID 818 for the United States 870a may be 2, the NID 820 may be 5, the value of LTM_OFF 824 may be 6, and DAYLT 822 may be ON. Likewise, the SID 818 for India 870b may be 2, the NID 820 may be 5, the value of LTM_OFF 824 may be 7, and DAYLT 822 may be ON. In this case, the UE 104 may be unable to differentiate between the United States 870a and India 870b. Such ambiguity may be resolved through a user prompt module 330 as discussed above in relation to FIG. 3. In contrast, Japan 870c may have an SID 818 of 3, an NID 820 of 4, a value for L™ OFF 824 of 4, and DAYLT 822 may be OFF. A UE 104 receiving these values in the sync channel message 316 may recognize that the current country is Japan 870c and not the United States 870a or India 870b, due to the non-ambiguity of the network information for Japan 870c.

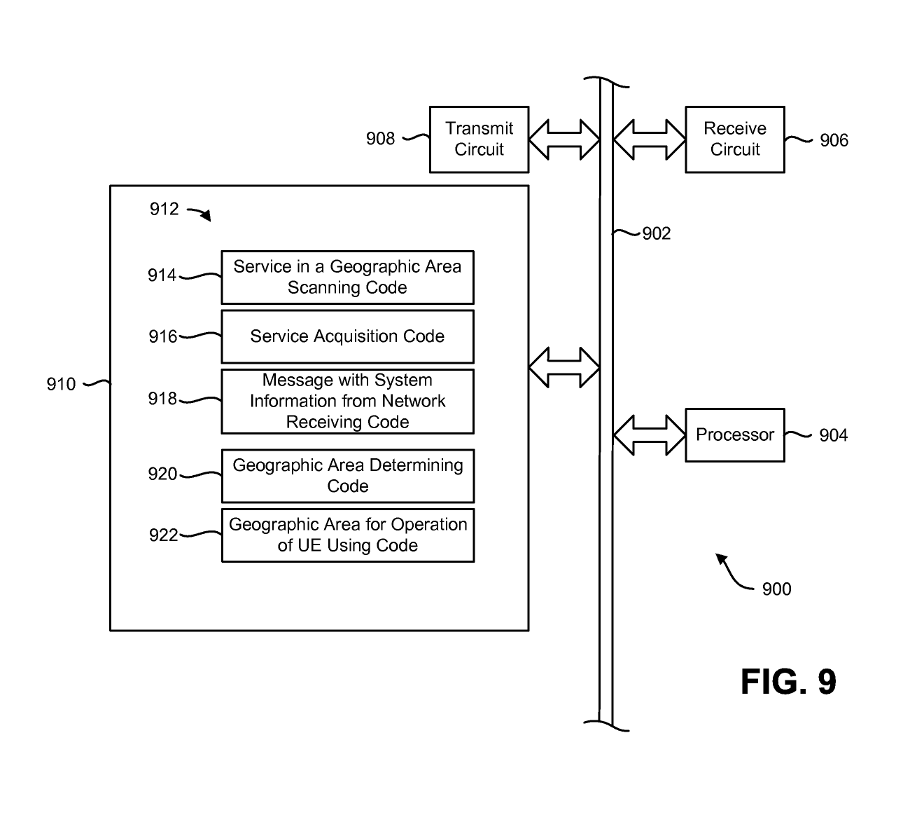

FIG. 9 shows part of a hardware implementation of an apparatus 900 that is configured for automatic selection of geographic area specific behavior. The apparatus 900 comprises circuitry as described below. In this specification and the appended claims, it should be clear that the term “circuitry” is construed as a structural term and not as a functional term. For example, circuitry can be an aggregate of circuit components, such as a multiplicity of integrated circuit components, in the form of processing and/or memory cells, units, blocks and the like, such as shown and described in FIG. 9.

In this embodiment, the circuit apparatus is signified by the reference numeral 900 and may be implemented in a wireless communication device. Examples of wireless communication device include cellular phones, handheld wireless devices, wireless modems, laptop computers, personal computers, etc.

The apparatus 900 comprises a central data bus 902 linking several circuits together. The circuits include a processor 904, a receive circuit 906, a transmit circuit 908, and memory 910. The memory 910 is in electronic communication with the processor 904, i.e., the processor 904 can read information from and/or write information to the memory 910.

The processor 904 may be a general purpose processor, a central processing unit (CPU), a microprocessor, a digital signal processor (DSP), a controller, a microcontroller, a state machine, an application specific integrated circuit (ASIC), a programmable logic device (PLD), a field programmable gate array (FPGA), etc. The processor 904 may include a combination of processing devices, e.g., a combination of a DSP and a microprocessor, a plurality of microprocessors, one or more microprocessors in conjunction with a DSP core, or any other such configuration.

The receive circuit 906 and the transmit circuit 908 can be connected to an RF (Radio Frequency) circuit, but that is not shown in the drawing. The receive circuit 906 may process and buffer received signals before sending the signals out to the data bus 902. On the other hand, the transmit circuit 908 may process and buffer the data from the data bus 902 before sending the data out of the device 900. The processor 904 may perform the function of data management of the data bus 902 and further the function of general data processing, including executing the instructional contents of the memory 910.

Instead of separately disposed as shown in FIG. 9, as an alternative, the transmit circuit 908 and the receive circuit 906 may be implemented in the processor 904.

The memory unit 910 includes a set of instructions generally signified by the reference numeral 912. The instructions 912 may be executable by the processor 904 to implement the methods described herein. The instructions 912 may include code 914 for scanning for service in a geographic area 106. The instructions 912 may also include code 916 for acquiring service. The instructions may also include code 918 for receiving a message with system information from a network. The instructions may further include code 920 for determining a geographic area 106. The instructions may also include code 922 for using the geographic area 106 for operation of a UE 104.

The instructions 912 shown in the memory 910 may comprise any type of computer-readable statement(s). For example, the instructions 912 in the memory 910 may refer to one or more programs, routines, sub-routines, modules, functions, procedures, data sets, etc. The instructions 912 may comprise a single computer-readable statement or many computer-readable statements.

The memory 910 may be a RAM (Random Access Memory) circuit. The memory 910 can be tied to another memory circuit (not shown) which can either be of the volatile or nonvolatile type. As an alternative, the memory 910 can be made of other circuit types, such as an EEPROM (Electrically Erasable Programmable Read Only Memory), an EPROM (Electrical Programmable Read Only Memory), a ROM (Read Only Memory), an ASIC (Application Specific Integrated Circuit), a magnetic disk, an optical disk, and others well known in the art. The memory 910 may be considered to be an example of a computer-program product that comprises a computer-readable medium with instructions 912 stored therein.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The terms “computer-readable medium” or “computer-program product” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 2, 4 and 5, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus for automatic selection of geographic specific behavior, comprising:
means for receiving a message with system information from a network, wherein the message is mandatorily sent from a base station; and
means for determining a geographic area in which the apparatus is located from the system information using a lookup table.

2. The apparatus of claim 1, further comprising means for scanning for service in the geographic area.

3. The apparatus of claim 1, further comprising means for acquiring service from the network in the geographic area.

4. The apparatus of claim 1, wherein the apparatus is configured to operate in a code division multiple access (CDMA) system.

5. The apparatus of claim 1, wherein the message is a sync channel message comprising a system identification (SID), a network identification (NID), a daylight savings time indicator (DAYLT), and a local time offset from system time (LTM_OFF).

6. The apparatus of claim 5, wherein the lookup table comprises the SID, NID, DAYLT, and LTM_OFF values of multiple geographic areas.

7. The apparatus of claim 1, wherein the geographic area is a country.

8. The apparatus of claim 1, further comprising means for prompting a user of the apparatus to select the geographic area if the determined geographic area is ambiguous.

9. The apparatus of claim 1, further comprising means for applying geographic area specific parameters to the apparatus.

10. The apparatus of claim 1, further comprising means for running geographic area specific applications on the apparatus.

11. The apparatus of claim 1, further comprising means for applying geographic area specific behaviors to the apparatus.

12. The apparatus of claim 1, wherein the message is received via a synchronization channel.

13. A wireless communication device configured for automatic selection of geographic specific behavior, comprising:
circuitry configured to receive a message with system information from a network and to determine a geographic area in which the wireless communication device is located from the system information using a lookup table, wherein the message is mandatorily sent from a base station.

14. The wireless communication device of claim 13, wherein the circuitry is further configured to scan for service in the geographic area.

15. The wireless communication device of claim 13, wherein the circuitry is further configured to acquire service from the network in the geographic area.

16. The wireless communication device of claim 13, wherein the wireless communication device is configured to operate in a code division multiple access (CDMA) system.

17. The wireless communication device of claim 13, wherein the message is a sync channel message comprising a system identification (SID), a network identification (NID), a daylight savings time indicator (DAYLT), and a local time offset from system time (LTM_OFF).

18. The wireless communication device of claim 17, wherein the lookup table comprises the SID, NID, DAYLT, and LTM_OFF values of multiple geographic areas.

19. The wireless communication device of claim 13, wherein the geographic area is a country.

20. The wireless communication device of claim 13, wherein the circuitry is further configured to prompt a user of the wireless communication device to select the geographic area if the determined geographic area is ambiguous.

21. The wireless communication device of claim 13, wherein the circuitry is further configured to apply geographic area specific parameters to the wireless communication device.

22. The wireless communication device of claim 13, wherein the circuitry is further configured to run geographic area specific applications on the wireless communication device.

23. The wireless communication device of claim 13, wherein the circuitry is further configured to apply geographic area specific behaviors to the wireless communication device.

24. The wireless communication device of claim 13, wherein the message is received via a synchronization channel.

25. A method for automatic selection of geographic specific behavior by a wireless communication device, comprising:
receiving a message with system information from a network, wherein the message is mandatorily sent from a base station, and
determining a geographic area in which the wireless communication device is located from the system information using a lookup table.

26. The method of claim 25, further comprising scanning for service in a geographic area.

27. The method of claim 25, further comprising acquiring service from the network in the geographic area.

28. The method of claim 25, wherein the wireless communication device is configured to operate in a code division multiple access (CDMA) system.

29. The method of claim 25, wherein the message is a sync channel message comprising a system identification (SID), a network identification (NID), a daylight savings time indicator (DAYLT), and a local time offset from system time (LTM_OFF).

30. The method of claim 29, wherein the lookup table comprises the SID, NID, DAYLT and LTM_OFF values of multiple geographic areas.

31. The method of claim 25, wherein the geographic area is a country.

32. The method of claim 25, further comprising prompting a user of the wireless communication device to select the geographic area if the determined geographic area is ambiguous.

33. The method of claim 25, further comprising applying geographic area specific parameters to the wireless communication device.

34. The method of claim 25, further comprising running geographic area specific applications on the wireless communication device.

35. The method of claim 25, further comprising applying geographic area specific behaviors to the wireless communication device.

36. The method of claim 25, wherein the message is received via a synchronization channel.

37. A computer-program product for a wireless device configured for automatic selection of geographic specific behavior, the computer-program product comprising a computer-readable medium having instructions thereon, the instructions comprising:
code for receiving a message with system information from a network, wherein the message is mandatorily sent from a base station; and
code for determining a geographic area in which the wireless device is located from the system information using a lookup table.

38. The computer-program product of claim 37, wherein the instructions further comprise code for scanning for service in the geographic area.

39. The computer-program product of claim 37, wherein the instructions further comprise code for acquiring service from the network in the geographic area.

40. The computer-program product of claim 37, wherein the wireless device is configured to operate in a code division multiple access (CDMA) system.

41. The computer-program product of claim 37, wherein the message is a sync channel message comprising a system identification (SID), a network identification (NID), a daylight savings time indicator (DAYLT), and a local time offset from system time (LTM_OFF).

42. The computer-program product of claim 41, wherein the lookup table comprises the SID, NID, DAYLT, and LTM_OFF values of multiple geographic areas.
